(19) United States
(12) Patent Application Publication
(10) Pub. No.: US 2011/0256830 A1
(43) Pub. Date: Oct. 20, 2011

(54) Wireless Communication Headset system

(76) Inventor: Chih-Chen LEE, Kaohsiung City (TW)

(21) Appl. No.: 12/837,674

(22) Filed: Jul. 16, 2010

(30) Foreign Application Priority Data
Apr. 15, 2010 (TW) 099206782

(51) Int. Cl. H04B 7/00

(52) U.S. Cl. 455/41.2

(57) ABSTRACT

A wireless communication headset system comprises a plurality of wireless communication headset devices and at least one transponder; in which the wireless communication headset device transmits a control signal in order to perform corresponding control actions with the signal and transmits a voice signal, while the transponder transmits the control signal to the wireless communication headset device within a communication range and transmits the voice signal. The transponder enables the functions of transmitting the control signal to the wireless communication headset device, creating connections among the plurality of wireless communication headset devices, controlling the communication mode of the wireless communication headset device and switching the communication channel. In addition, when the transponder moves, the communication range shifts accordingly along with the transponder as well.

### BACKGROUND OF THE INVENTION

1. Field of the Invention

The present invention relates to a wireless communication headset system; in particular, to a wireless communication headset system capable of employing a plurality of headsets in conjunction with the transponder to switch among different communication modes in use.

2. Description of Related Art

Currently available Bluetooth™ or wireless headsets do not enable the headset-to-headset communication function; rather, a major device is still required so as to send the voice signal to the headset. In addition, the existing radio technologies are implemented in a form of analog transmissions, causing potential risks regarding to the issue of security; e.g., vulnerability to frequency interference, hackings of communication channel, thus resulting in reduced safety and protection.

However, the wireless intercom used today identifies the user based on divided channels, and, within a certain signal range, the overlap of such divided channels usually occurs thus leading to a phenomenon that several users may together communicate simultaneously on the same divided channel, causing undesirable mutual interferences. Unfortunately no existing intercom can provide the function of communication mode switching.

Also, for travelling on a bicycle or motorcycle and participating in outdoor group activities, it needs to consider about the factor of security in motion. Generally, people may talk with each other on bicycle or motorcycle during such outdoor activities in motion. Whereas, should any emergent condition occurs in front, since the eyesight of the driver may not be placed in the forward direction while chatting, it tends to result in the danger of collision or other traffic accidents. Besides, people may need to speak aloud which potentially exposes personal privacy.

In view of the aforementioned drawbacks, the inventors of the present invention have devoted themselves in order to find the improvement and renovation therefore. Hence, after long-term researches with great amount of efforts, the wireless communication headset system according to the present invention is hereby provided.

### SUMMARY OF THE INVENTION

Regarding to the defects found in prior art, the objective of the present invention is to provide a wireless communication headset system so as to resolve the problems of bad communication and insufficient security consideration during outdoor activities, conjunctively enhancing the personal privacy protection between communications.

According to the objective of the present invention, a wireless communication headset system is provided, comprising a plurality of wireless communication headset devices and at least one transponder. The wireless communication headset device transmits a control signal in order to perform corresponding control actions with the signal and transmits a voice signal, while the transponder transmits the control signal to the wireless communication headset device within a communication range and transmits the voice signal. The transponder enables the functions of transmitting the control signal to the wireless communication headset device, creating connections among the plurality of wireless communication headset devices, controlling the communication mode of the wireless communication headset device and switching the communication channel, and when the transponder moves, the communication range shifts accordingly along with the transponder as well.

Herein the wireless communication between the wireless communication headset device and the transponder follows 802.11, 802.15 or Bluetooth™ communication protocol to facilitate transmissions of the voice signal and the control signal.

Herein the number of the transponders may be plural, with each of the plural transponders being able to mutually transmit the control signal and the voice signal in order to expand the communication range.

Herein the wireless communication headset device respectively has a specific serial number or a particular name (possibly in symbols or texts), in which the specific serial number or particular name is unique without repetition.

Herein an encryption on the pairing and the connection between the wireless communication headset device and the transponder is enabled by using a specific password, the pairing and the connection among the transponders also use a specific password, and communication there between through signals can be allowed if these passwords match. Such a specific password is set by the user.

Herein the pairing and the connection between the wireless communication headset device and the transponder, as well as the pairing and the connection among the transponders, also provide an open function which enables free use of the signal through connection in series based on the increased number of transponders without having to use the specific password.

Herein the communication mode of the wireless communication headset device consists of a peer-to-peer communication mode, a multi-party communication mode and a broadcast communication mode; the peer-to-peer communication mode can be enabled between any two of the wireless communication headsets, mutually communicating by using a specific serial number or a specific name (possibly in symbols or texts). The multi-party communication mode indicates that one user of a wireless communication headset device simultaneously communicates with other multiple users of their respective wireless communication headset devices. The broadcast communication mode means that, within the communication range of a transponder, one of many wireless communication headset devices can connect to other wireless communication headset devices for broadcasting.

Herein the wireless communication headset further provides the function of transmitting the switch request for communication mode with the control signal and selecting a specific communication serial number for communication.

Herein the wireless communication headset comprises a first processing unit, a first transceiving unit, a first memory unit, a first display unit, a voice source output unit and a first input unit. The first processing unit generates a control signal for switching the communication mode. The first transceiving unit is coupled to the first processing unit thereby enabling transmissions of the voice signal and the control signal through a first antenna. The first memory unit is coupled to the first processing unit thereby enabling the storage of a table constituted by the specific serial numbers or the specific names (possibly in symbols or texts). The first display unit is coupled to the first processing unit which provides graphic and textual presentations. The voice source output unit is coupled to the first processing unit for converting the voice signal into the voice and providing the resulted output. The first input unit is coupled to the first processing unit which is formed by a plurality of buttons for user's operations.

Herein the transponder comprises a second processing unit, a second transceiving unit, a second memory unit, a second display unit and a second input unit. The second processing unit performs the switching of the communication mode, the arrangement of communication channels, the creation of connections based on the specific serial number or the specific name (possibly in symbols or texts) as well as system setup. The second transceiving unit enables transmissions of the voice signal and the control signal through a second antenna. The second memory unit enables the storage of a table constituted by the specific serial numbers or the specific names (possibly in symbols or texts). The second display unit provides graphic and textual presentations. The second input unit is formed by a plurality of buttons for user's operations.

### BRIEF DESCRIPTION OF THE DRAWINGS

FIG. 1 shows a diagram for the architecture of a wireless communication headset in the wireless communication headset system according to the present invention;

FIG. 2 shows a diagram for the architecture of a transponder in the wireless communication headset system according to the present invention;

FIG. 3 shows a diagram for the system architecture of the wireless communication headset system according to the present invention; and

FIG. 4 shows a diagram for an embodiment of the wireless communication headset system according to the present invention.

### DETAILED DESCRIPTION OF THE PREFERRED EMBODIMENTS

In the following descriptions, reference will be made to the appended drawings in order to illustrate in details the embodiments of the wireless communication headset system according to the present invention. For the purpose of clarity, the identical components employed in the embodiments are denoted with the same marks/symbols throughout the disclosure.

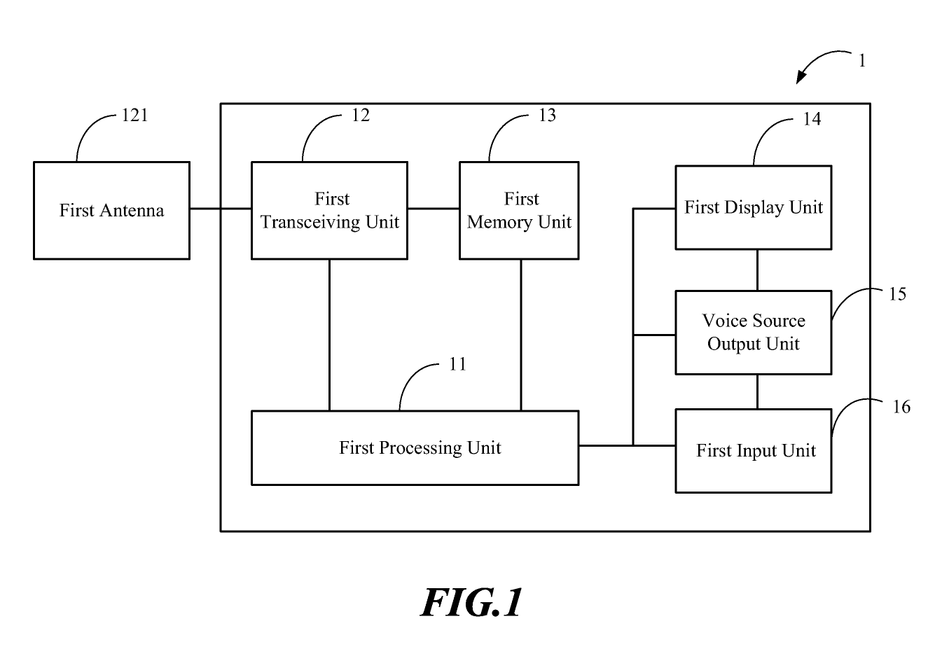

Refer initially to FIG. 1, wherein a diagram for the architecture of a wireless communication headset in the wireless communication headset system according to the present invention is shown. As illustrated in the Figure, the wireless communication headset 1 comprises: a first processing unit 11, a first transceiving unit 12, a first memory unit 13, a first display unit 14, a voice source output unit 15 and a first input unit 16. The first processing unit 11 generates a control signal for switching the communication mode, which may be for example a small central processing unit (CPU). The first transceiving unit 12 is coupled to the first processing unit 11 thereby enabling transmissions of the voice signal and the control signal through a first antenna 121 in accordance with the communication protocol such as 802.11, 802.15 or Bluetooth™ etc. The first memory unit 13 is coupled to the first processing unit 11 thereby enabling the storage of a table constituted by the specific serial numbers or the specific names (possibly in symbols or texts) for creating connections with other user's wireless communication headset 1. The first display unit 14 is coupled to the first processing unit 11 which provides graphic and textual presentations and may be, for example, a liquid crystal display (LCD). The voice source output unit 15 is coupled to the first processing unit for converting the voice signal into the voice and providing the resulted output, which may be like a commonly used speaker. The first input unit 16 is coupled to the first processing unit which may be formed by a plurality of buttons, or alternatively a touch panel, for user's operations.

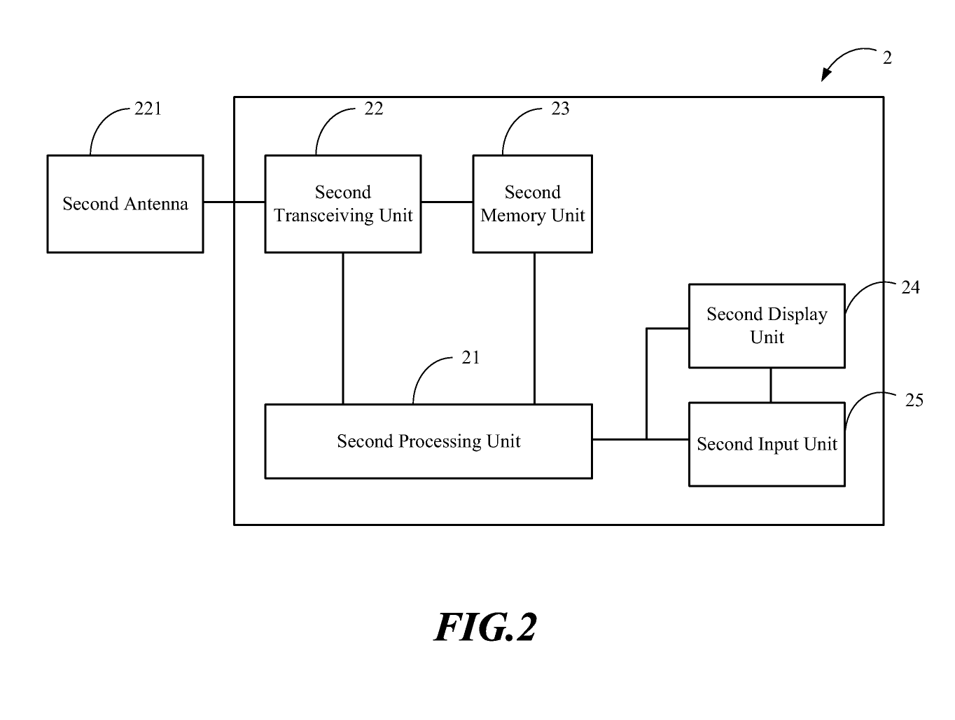

Refer next to FIG. 2, wherein a diagram for the architecture of a transponder in the wireless communication headset system according to the present invention is shown. As illustrated in the Figure, the transponder 2 comprises: a second processing unit 21, a second transceiving unit 22, a second memory unit 23, a second display unit 24 and a second input unit 25. The second processing unit 21 performs the switching of the communication mode, the arrangement of communication channels, the creation of connections based on the specific serial number or the specific name (possibly in symbols or texts) as well as system setup, which may be also a small CPU. The second transceiving unit 22 enables transmissions of the voice signal and the control signal through a second antenna 221. The second memory unit 23 enables the storage of a table constituted by the specific serial numbers or the specific names (possibly in symbols or texts), thereby holding the specific serial numbers of all available wireless communication headset devices. The second display unit 24 provides graphic and textual presentations. The second input unit may be formed by a plurality of buttons, or alternatively a touch panel, for user's operations.

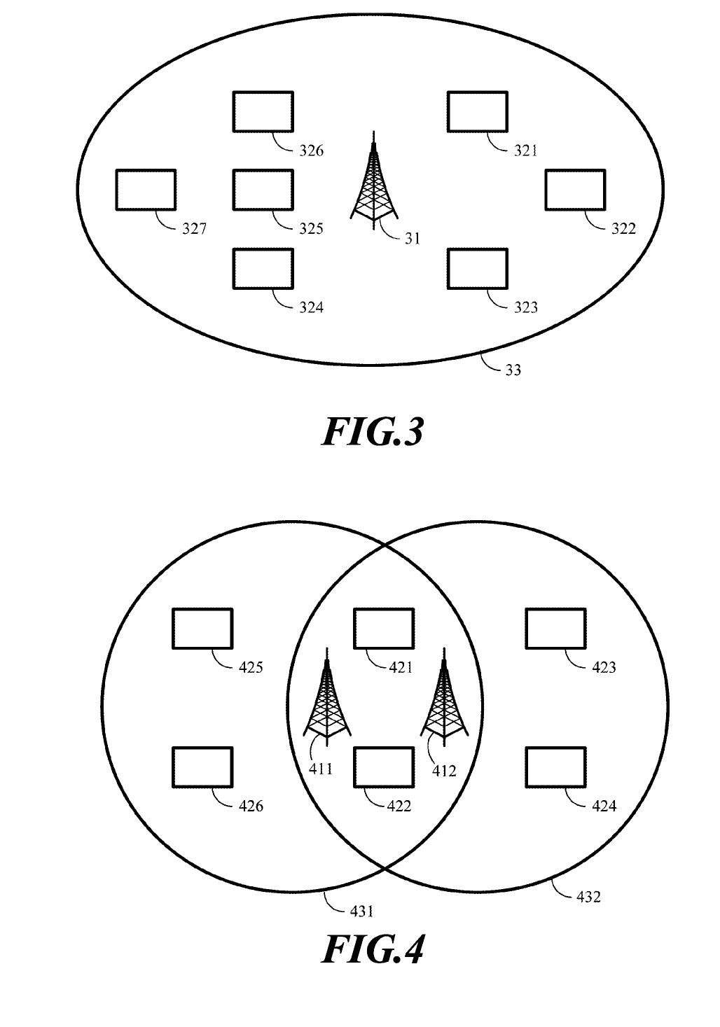

Refer now to FIG. 3, wherein a diagram for the system architecture of the wireless communication headset system according to the present invention is shown. As illustrated in the Figure, a plurality of wireless communication headset devices 321˜327 are placed in the vicinity nearby the transponder 31. The number of such headset devices is exemplarily illustrated in the Figure as seven (7), but it is by no means limited thereto in practice. The transponder 31 performs signal emissions whose communication range 33 may be up to a distance of 1000 meters, and also the transmission power generated by the transponder 31 is set to be below 13 dB in considering the factor of potential risk against human body safety; the same security principle also applies to the transmission power of the wireless communication headset devices 321˜327. All communication features in relation to the wireless communication headset devices 321˜327, including communication mode, parameter settings and system setup, can be completed at the transponder 31, and the specific serial numbers or the specific names of the wireless communication headset devices 321˜327 located within the communication range are stored in respective memory unit of each wireless communication headset device 321˜327 and transponder 31.

Refer then to FIG. 4, wherein a diagram for an embodiment of the wireless communication headset system according to the present invention is shown. As illustrated in the Figure, the transponder 411 and the transponder 412 partially overlap with each other, and since the communication range 431 generated by the transponder 411 and the communication range 432 generated by the transponder 412 both follow 802.11, 802.15 or Bluetooth™ communication protocol, the transponder 411 and the transponder 412 are allowed to mutually communicate, in which all of the wireless communication headset devices 421˜426 within the coverage of these two communication ranges are allowed to connect with each other. In the present embodiment, six (6) wireless communication headset devices are exemplarily shown, but the number of devices is by no means limited thereto in practice. The communication between the wireless communication headset devices 421˜426 is performed based on respective specific serial number or specific name (possibly in symbols or texts) for each of wireless communication headset devices 421˜426; in case that the wireless communication headset device 421 intends to communicate with the wireless communication headset device 422, the user may first press down the button on the wireless communication headset devices 421 for direct input, or else through assistance of the display unit on the wireless communication headset device 421, so as to initiate the communication linkage. Suppose that the wireless communication headset device 421 is under the control of the transponder 411, it may send the control signal to the transponder 411, and the transponder 411 is responsible for connecting to the wireless communication headset device 422. At this point, the wireless communication headset device 422 may be equipped with a buzzer or an indicator (e.g., a light emitting component, such as an LED) to prompt the user of the wireless communication headset device 422 to answer the incoming call, then the user of the wireless communication headset device 422 may press down a button to answer and start the communication session.

Refer again to FIG. 4, in which the user may further use the function of communication mode switching to undergo different types of communications. Allowable options for communication mode may include: peer-to-peer communication mode, multi-party communication mode and broadcast communication mode, in which the peer-to-peer communication mode has been described as above. The multi-party communication mode allows selection of several specific serial numbers or specific names (possibly in symbols or texts) of multiple wireless communication headset devices intended to communicate with; for example, the user of the wireless communication headset device 421 may wish to choose the specific serial numbers or the specific names (possibly in symbols or texts) of the wireless communication headset device 422 and the wireless communication headset device 423, and after transmissions of communication requests, the respective buzzer or indicator on the wireless communication headset device 422 and the wireless communication headset device 423 can be activated, and then the multi-party communication can be activated upon reception of respective response thereof. In terms of the broadcast communication mode, for example, suppose that the user of the wireless communication headset device 422 intends to broadcast toward all of the wireless communication headset devices 421, 423, 424, 425 and 426 located within the communication range, the user of the wireless communication headset device 422 may select the broadcast function, and all of the wireless communication headset devices 421, 423, 424, 425 and 426 are connected for receiving the voice signal through broadcast.

In summary, the wireless communication headset system according to the present invention provides one or more of the follow advantages:

1. the present invention can be applied to communication tools utilized in an exhibition hall, a bicycle team or other group activities in motion, which advantageously enables broadcast mode, multi-party mode or peer-to-peer communication mode;

2. the present invention allows to reduce the risk due to face-to-face conversation in the course of bicycle or motorcycle travelling in motion, ensuring linkage and location identification of the members during outdoor group activities, thereby preventing possible missing or straying problems;

3. in case that the number of transponder increases, the present invention effectively enlarges the communication range thereby allowing comprehensive extension of the application field;

4. the present invention allows to set the number of headsets, determine the transfer function and assign the headset or the transponder for completing the operation based on the actual application environment.

The aforementioned illustrations are simply exemplary, rather than restrictive in any sense. All effectively equivalent modifications or alternations made thereto without departing from the spirit and scope of the present invention are deemed to be included in the field of the present invention as defined by the claims set forth hereunder.

What is claimed is:

1. A wireless communication headset system, comprising:
a plurality of wireless communication headset devices which transmits a control signal in order to perform corresponding control actions with the signal and transmits a voice signal; and
at least one transponder which transmits the control signal to the wireless communication headset device within a communication range and transmits the voice signal;
wherein the transponder enables the functions of transmitting the control signal to the wireless communication headset devices, creating connections among the plurality of wireless communication headset devices, controlling the communication mode of the wireless communication headset device and switching the communication channel, and when the transponder moves, the communication range shifts accordingly along with the transponder as well.

2. The wireless communication headset system according to claim 1, wherein the wireless communication between the wireless communication headset devices and the transponder uses 802.11, 802.15 or Bluetooth™ communication protocol.

3. The wireless communication headset system according to claim 1, wherein the transponder can be plural and the control signal and the voice signal can be mutually transmitted among such plural transponders in order to expand the communication range.

4. The wireless communication headset system according to claim 1, wherein the wireless communication headset device respectively has a specific serial number or a specific name, which specific serial number or specific name being unique without repetition.

5. The wireless communication headset system according to claim 1, wherein an encryption on the pairing and the connection between the wireless communication headset device and the transponder is enabled by using a specific password, the pairing and the connection among the transponders also use a specific password, and communication there between through signals is allowed if these passwords match, in which such a specific password is set by the user.

6. The wireless communication headset system according to claim 1, wherein the communication mode of the wireless communication headset devices consists of the following optional combinations:
a peer-to-peer communication mode, in which the communication is enabled by any two of the wireless communication headsets, mutually communicating by respectively using the specific serial number or the specific name;
a multi-party communication mode, in which the communication is enabled in a way that one user of a wireless communication headset device simultaneously communicates with other multiple users of their respective wireless communication headset devices; and
a broadcast communication mode, in which the communication is enabled in a way that, within the communication range of the transponder, one of the wireless communication headset devices broadcasts to all other wireless communication headset devices.

7. The wireless communication headset system according to claim 1, wherein the wireless communication headsets further provides the function of transmitting the switch request for communication mode with the control signal and selecting the specific communication serial number or the specific name for communication.

8. The wireless communication headset system according to claim 1, wherein the wireless communication headset comprises:
a first processing unit, which generates a control signal for switching the communication mode;
a first transceiving unit, which is coupled to the first processing unit thereby enabling transmissions of the voice signal and the control signal through a first antenna;
a first memory unit, which is coupled to the first processing unit thereby enabling the storage of a table constituted by the specific serial numbers or the specific names;
a first display unit, which is coupled to the first processing unit which provides graphic and textual presentations;
a voice source output unit, which is coupled to the first processing unit for converting the voice signal into the voice and providing the resulted output; and
a first input unit, which is coupled to the first processing unit which is formed by a plurality of buttons for user's operations.

9. The wireless communication headset system according to claim 1, wherein the transponder comprises:
a second processing unit, which performs the switching of the communication mode, the arrangement of communication channels, the creation of connections based on the specific serial number or the specific name as well as system setup;
a second transceiving unit, which enables transmissions of the voice signal and the control signal through a second antenna;
a second memory unit, which enables the storage of a table constituted by the specific serial numbers or the specific names;
a second display unit, which provides graphic and textual presentations; and
a second input unit, which is formed by a plurality of buttons for user's operations.
